(19) United States
(12) Patent Application Publication
(10) Pub. No.: US 2008/0243594 A1
(43) Pub. Date: Oct. 2, 2008

(54) ORDER PROMOTION SYSTEM

(75) Inventor: Yusuke Kitagawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,826

(22) Filed: Mar. 31, 2008

(30) Foreign Application Priority Data
Mar. 30, 2007 (JP) 2007-091603

(51) Int. Cl. G06Q 30/00

(52) U.S. Cl. 705/10; 705/26

(57) ABSTRACT

In an order promotion system, the storage management server reads out, from the storage means, the order inquiry information corresponding to the member identification number transmitted from the retailer system, and transmits the order inquiry information to the retailer system, and the retailer system judges, based on the order inquiry information received from the storage management server and the order inquiry condition stored in the condition storage means, whether it is possible to make an order inquiry to the user with regard to one of the information data and each of the commercial products, determines a content of the order inquiry, and makes an order inquiry based on a judgment result corresponding to a result of the judgment and the determination.

### BACKGROUND OF THE INVENTION

The present invention relates to an order promotion system for managing information data such as image data and music data of users stored in a server and performing a production process of producing commercial products in the form of photographs, CDs, and the like, in accordance with orders from the users.

Along with the proliferation of online order processing systems in recent years, it is becoming common practice to place a print order for photographs or the like via a network, using the Internet or a reception machine installed at a shop. There is also provided service for storing image data of users in a server to a certain amount or for a certain period. By taking advantage thereof, a user can upload image data, which is obtained by taking images with a digital camera or a camera-equipped cell phone, to a server to store the image data therein, in a case where a data amount of images recorded in the camera has increased to a large amount, or in a case where the maximum storage capacity of the camera has been reached to run short of the memory capacity. Further, there is also provided service for allowing a user to select, on the Web, preferred images from the image data stored in the server and to place an order for a product such as a photo print of the images.

Various methods are adopted for the above-mentioned order processing system for enabling a user to place an order smoothly with ease.

For example, JP 2006-318165 A discloses a print ordering system, in which a user can speedily place a print order with high efficiency when the user is placing the print order from a digital camera. In the print ordering system according to JP 2006-318165 A, images to be ordered for print are primarily selected on the digital camera side to make setting for the print order, and the order reception machine thereafter makes a final selection of images to be ordered and sets the number of prints. Accordingly, images to be ordered for print can be selected on both of the digital camera side and the order reception machine side, thereby allowing a user to speedily place a print order.

Also, JP 2006-331173 A discloses a remote controller for placing an order for photo print, which enables even a customer unused to operating a personal computer to easily place an online-order for photo print. According to JP 2006-331173 A, a unique remote controller which can be operated with ease is connected to the Internet, and a print order is placed through the operation of the remote controller, to thereby simplify the order process and allow even a customer unused to operating a personal computer to smoothly place an order.

Further, along with the emergence of a next generation cell phone with high communication speed and a television having a PC function due to the commencement of digital broadcasting, it is highly likely that each user uploads image data or music data, through, for example, a television or a PC, to a storage server provided by a company to store the data in the server, as well as storing the data in a user's own PC.

In view of the situation where the above-mentioned online storage of data has been growing in demand due to the spread of network service, more importance is attached to a method of storing and managing data in a storage server than ever.

Meanwhile, in the online order processing system using a personal computer or a reception machine as described above, there may occur a case where a user having no intention of placing an order makes an order for print deliberately on malicious purpose and just leaves the order as it is without receiving prints or making a payment therefor, which is so called a mischievous order. In order to prevent the mischievous order from being placed, there have been devised various methods.

For example, JP 2006-004172 A discloses an image formation order system capable of preventing the mischievous order from being placed. In the image formation order system according to JP 2006-004172 A, when an order is received from a new orderer on the Internet, orderer data of the orderer is stored in a database. After that, when a case has occurred where the orderer does not come to receive a product for the placed order or does not make a payment for the order, the orderer is regarded as having placed the mischievous order, and the orderer data of the orderer is separately stored in a list form. When another order is received from an orderer, the orderer is compared, in advance, with the orderer data stored in the list. In a case where the list includes the orderer data corresponding to the orderer, the order is not automatically put into production of prints assuming that the orderer may have placed the mischievous order, and an operator determines whether or not to carry on the print production process. The above-mentioned method according to JP 2006-004172 A may be capable of efficiently dealing with an order made on malicious purpose, to thereby prevent the mischievous order from being placed.

The conventional order processing system has an advantage that users can place orders with ease. However, any of the above-mentioned technologies works effectively only when the user has a positive intention to place an order and performs an order operation. In other words, it is not possible to derive an order from a user who is just satisfied by merely storing image data in the server and has no intention of placing an order therefor.

Further, as described above, in the order processing system, it is necessary to take prevention measures against the mischievous order. The system disclosed in JP 2006-004172 A works effectively only with respect to a user who has once made an order and has already been registered in the list. That is, the system would be of help only to preventing the mischievous order from being placed for the second time or later, but cannot deal with the mischievous order placed for the first time by a new user.

Also, in the order processing system, a print order can be placed on the Web. When an order is placed on the Web, it is general to charge the order to a credit card of the user simultaneously with the placement of the order, or to charge the user for the order upon reception of the ordered print at a shop or by mail. However, when a credit card is used for the payment, information such as a card number should be input, which may lead to a case where the input information is abused by a third party to place the mischievous order by a person other than the user, and further to a case where, when the third party is ill-intentioned, the user is defrauded of the ordered product or cash only to be charged therefor, leading to a problem that the user has to take a risk in terms of security. Alternatively, in the case where an order is charged upon reception of a product, the production side has to take a risk of sustaining a loss by failing to collect the charge when the user has merely placed an order but does not come to receive the ordered product. Further, in the case where an order is charged upon reception of a product by mail, there is a fear that an order be maliciously placed such that the ordered product is to be mailed to a third party's address on purpose and the third party who has not placed the order be charged for the order.

Alternatively, there is another method, in which, for example, an order for a predetermined number of prints is received by collecting a constant amount of a fee from each user in advance each month. According to this method, it is possible to prevent the mischievous order from being placed by charging a constant amount of money to users each month, but the certain amount of money is constantly collected each month regardless of whether the user has placed an order in the month, which causes inconvenience to a user who does not place an order for print periodically.

There is still another method in which an order is charged simultaneously with the placement thereof at a reception terminal installed at a shop such as a laboratory, and production for the order is started regarding that the reception of the order has been completed at a time point when the charge is completed. In this case, it is possible to reliably charge the order, but the user has to take the trouble of coming to the reception terminal, which causes inconvenience to the user.

Further, the above-mentioned order processing systems or methods are targeted for a user having an intention of placing an order, and therefore it is not possible to derive an order from a user who is just satisfied by merely storing image data in a server and has no intention of placing an order therefor.

### SUMMARY OF THE INVENTION

The present invention has been made to solve the above-mentioned problems inherent in the related art, and it is an object of the present invention to provide an order promotion system which provides service of storing information data of users in a server for free, to thereby promote the storage of information data in the server, and is capable of encouraging a user who just stores information data and has no intention of placing an order therefor to place an order for a product related to the information data, without causing offense to the feelings of the user, to thereby allow a user, who hitherto has not had an intention to place an order, to place an order without psychological discomfort therein.

Also, in addition to the above-mentioned object, it is another object of the present invention to provide an order promotion system capable of reliably preventing mischievous orders from being placed, without posing risks to or placing a burden on users or product manufacturers.

In order to achieve the above-mentioned object, according to an aspect of the present invention, there is provided an order promotion system, including:

a storage management server; and

at least one retailer system,

the storage management server including:

an acquisition means for acquiring one of information data including one of image data and music data uploaded by a user through a communication network, and a storage status of the information data thus uploaded;

an analysis means for analyzing order inquiry information related to the information data, based on the acquired one of the information data and the storage status; and

a storage means for storing one of the information data and the storage status, in association with the order inquiry information; and

the at least one retailer system including:

an identification information acquisition means for acquiring a member identification information of the user;

a condition storage means for storing an order inquiry condition; and

a sales management function of managing sales of commercial products,

wherein:

the retailer system transmits the member identification information acquired by the identification information acquisition means, to the storage management server;

the storage management server reads out, from the storage means, the order inquiry information corresponding to the received member identification information, and transmits the order inquiry information to the retailer system,

the retailer system judges, based on the order inquiry information received from the storage management server and the order inquiry condition stored in the condition storage means, whether it is possible to make an order inquiry to the user with regard to one of the information data and each of the commercial products, determines a content of the order inquiry, and makes an order inquiry based on a judgement result corresponding to a result of the judgment and the determination.

Further, in order to achieve the above-mentioned object, there is provided an order promotion system, including:

a storage management server; and

a retailer system,

the storage management server including:

an acquisition means for acquiring one of information data including one of image data and music data uploaded by a user through a communication network, and a storage status of the information data thus uploaded;

an analysis means for analyzing order inquiry information related to the information data, based on the acquired one of the information data and the storage status;

a storage means for storing one of the information data and the storage status, in association with the order inquiry information; and

a condition storage means for storing an order inquiry condition,

the retailer system including an identification information acquisition means for acquiring a member identification information of the user,

wherein:

the retailer system transmits the member I identification information acquired by the identification information acquisition means, to the storage management server;

the storage management server reads out, from the storage means, the order inquiry information and the order inquiry condition each corresponding to the received member identification information, judges, based on the order inquiry information and the order inquiry condition, whether it is possible to make an order inquiry to the user with regard to one of the information data and each of commercial products, determines a content of the order inquiry, and transmits a judgment result corresponding to a result of the judgment and the determination, to the retailer system; and

the retailer system makes an order inquiry based on the received judgment result.

In the above center server, preferably, the storage management server includes an authentication means for authenticating a user uploading the information data, based on a login identification information of the user; and

the storage means stores the uploaded information data, in association with the login identification information and the member identification information.

Further, preferably, the order inquiry information includes at least one of first inquiry information and second inquiry information,

the first inquiry information including order inquiry authorization information and order intention information of a user regarding one of the information data and each of the commercial products,

the second inquiry information including at least one of: information on the time at which the information data has been last uploaded; information as to whether there is stored any information data about which an order inquiry is yet to be made; information on the number of image data files for which a print order is yet to be placed; information on a size of the image data files for which a print order is yet to be placed; information on the number of the image data files yet to be recorded on a recording medium; information on a size of the image data files yet to be recorded on a recording medium; information on the number of music data files yet to be recorded on a recording medium; and information on a size of the music data files yet to be recorded on a recording medium.

Further, preferably, the order inquiry condition includes a condition for judging, based on the order inquiry information, whether it is possible or not to make an order inquiry with regard to one of the information data and each of the commercial products;

the first inquiry information has a condition that a user allows an order inquiry to be made and has an intention of placing an order, as the order inquiry condition;

the second inquiry information has a result of a comparison between each of the information data items and a predetermined threshold value, set as the order inquiry condition; and

when all the order inquiry conditions are satisfied, it is judged that an order inquiry is possible.

Further, preferably, the order inquiry information further includes information including a content of an order inquiry made to a user and a date and time on which the order inquiry has been made in response to which the user has not placed an order, as third inquiry information; and

the order inquiry condition is set such that the judgment as to whether it is possible to make an order inquiry is allowed to be made according to the third inquiry information, only in a case where it has been judged, according to the first inquiry information, that the order inquiry is possible and a user has an intention of placing an order.

Further, preferably, the retailer system includes a display means for displaying, based on the judgment result, commercial products about which an order inquiry can be made.

Further, preferably, further including a production unit for performing a production process for producing a corresponding one of the commercial products based on an order placed by a user through the retailer system, wherein:

the retailer system includes an order reception means for receiving an order from a user;

the order reception means, upon receiving an order from a user in response to the order inquiry, charges the user for the order, and transmits order information to the production unit; and

the production unit, upon receiving the order information, obtains, from the storage management server, the information data corresponding to the order information, and performs the production process.

Further, preferably, the storage management server includes a management server and at least one storage server storing server usage fee information;

the storage means stores identification information of the at least one storage server in association with the member identification information;

the storage management server, upon receiving the member identification information from the retailer system, reads out the identification information of the at least one storage server which has been associated with the member identification information by the storage means, obtains the server usage fee information of the at least one storage server, and notifies the retailer system of the server usage fee information; and

the retailer system charges the user for an amount obtained by adding a server usage fee based on the notified server usage fee information to a production fee of the corresponding one of the commercial products.

Further, preferably, the retailer system issues a new member identification information and transmits the new member identification information, together with identification information of the retailer system, to the storage management server;

the storage management server issues a new login identification information based on the new member identification information and the identification information of the retailer system received from the retailer system; and

the storage means stores and manages the new member identification information and the new login identification information in association with each other.

Further, preferably, the retailer system issues a new member identification information and transmits the new member identification information, together with a login identification information reported by a user, to the storage management server; and

the storage management server stores and manages, in the storage means, the received new member identification information and the login identification information in association with each other.

Further, preferably, the authentication means, upon acquiring the login identification information, reads out, from the storage means, the identification information of the corresponding storage server, based on the member identification information associated with the login identification information, and automatically effects a transition to the specific storage server based on the identification information of the storage server.

Further, preferably, the storage management server further includes a face detection means for determining, in a case where the uploaded information data includes image data, the number of faces, and providing the number of faces as the number of prints to be ordered for the image data, to the image data as additional information.

Further, preferably, the storage management server further includes a number setting function of allowing a user to arbitrarily set the number of commercial products to be produced for image data.

Further, preferably, further including a detailed order unit for making a setting in detail on an order, based on the order inquiry information and the order inquiry condition, wherein

the retailer system transfers the order inquiry information and the order inquiry condition to the detailed order unit.

Further, preferably, the retailer system includes a print unit for printing a delivery form to be used for delivering the corresponding one of the commercial products to a user.

Further, preferably, the order reception means includes means for calculating a production completion time of the corresponding one of the commercial products based on the order information and indicating the production completion time to a user.

Further, according to the present invention, there is provided a storage management server provided to the order promotion system according to any one of above mentioned.

Further, according to the present invention, a retailer system provided to the order promotion system according to any one above mentioned.

The order promotion system according to the present invention provides service of storing information data in a server without charge, to thereby promote the storage of information data of users in the server. Also, in the order promotion system, when a user does shopping at a retailer such as a supermarket, unordered information data is displayed to the user to encourage the user to place an order for a product related to the information data, to thereby make it possible to make an order inquiry to a user who just stores information data in the server and has no intention of placing an order. Further, the order inquiry is made based on the inquiry information and the inquiry condition, which are set in advance, thereby making it possible to encourage a user to place an order without causing offense to the feelings of the user.

Also, according to the order promotion system of the present invention, it is possible to charge an order simultaneously with the placement thereof, to thereby reliably prevent mischievous orders from being placed without posing risks to or placing a burden on users or product manufacturers. Further, a placed order is charged to a user when the user makes a payment for a purchase in daily life, which eases user's psychological discomfort in making a payment for the order.

Further, according to the present invention, users can store information data which includes not only image data but also various kinds of data including music data, and place an order therefor.

### BRIEF DESCRIPTION OF THE DRAWINGS

In the accompanying drawings:

FIG. 1 is a block diagram illustrating an example of a system configuration of an order promotion system according to the present invention;

FIG. 2 is a block diagram illustrating a configuration example of each function of the order promotion system according to the present invention;

FIG. 3 is a diagram illustrating an example of an order screen; and

FIG. 4 is a block diagram illustrating another configuration example of each function of the order promotion system according to the present invention.

### DETAILED DESCRIPTION OF THE PREFERRED EMBODIMENTS

Hereinbelow, an order promotion system according to the present invention will be described in detail with reference to preferred embodiments illustrated in the accompanying drawings.

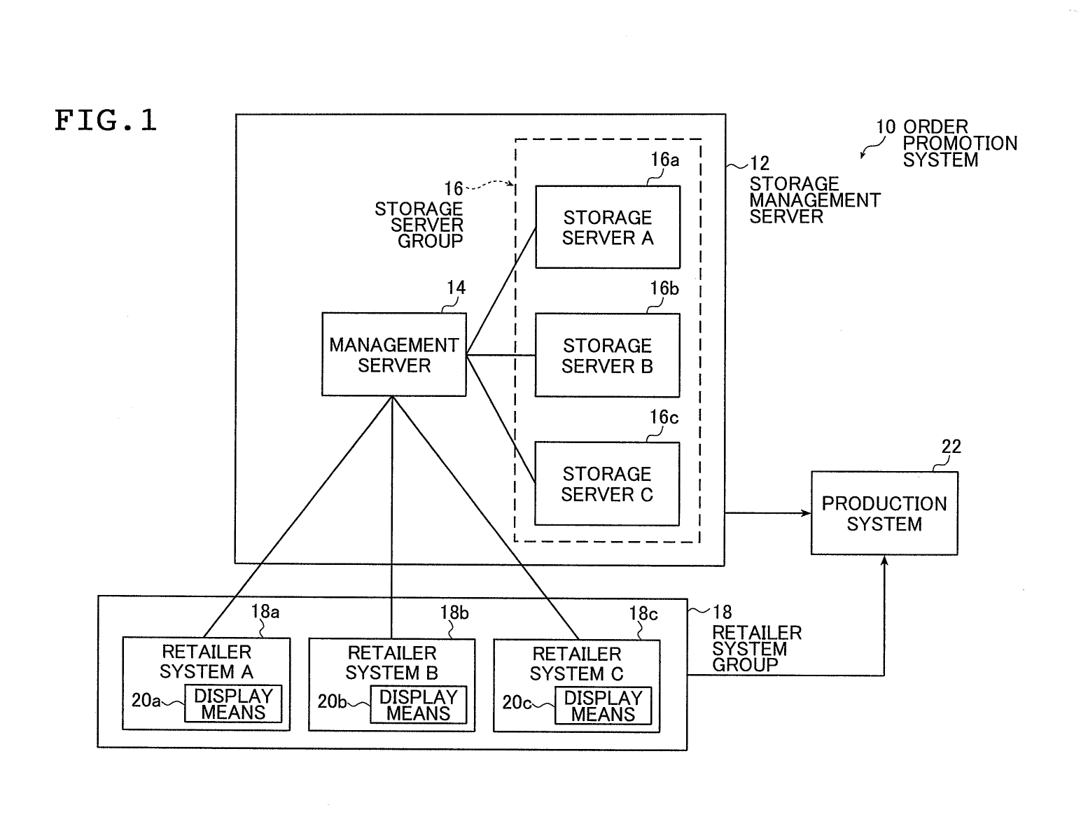

FIG. 1 is a block diagram illustrating an embodiment of a configuration of the order promotion system according to the present invention.

The order promotion system according to the present invention stores, in a server, information data such as image data or music data uploaded by users through a Web site or the like via a network, and manages the information data. Further, the order promotion system receives orders for various products related to the information data stored in the server, and produces commercial products. The products include prints to be created based on the image data and recording media such as CDs on which the image data or the music data is recorded, according to each order placed by each user.

The order promotion system according to the present invention includes a storage phase for receiving information data via a network, and storing and managing the information data in a server, and an order phase for processing orders made for products to be produced based on the information data stored in the server. The storage phase and the order phase each function independently of each other.

The storage phase includes a storage management server for storing information data. The storage management server provides a certain amount of the capacity in the server to a user for free (without charge), and stores information data such as image data or music data uploaded by the user. Further, regardless of whether the user places an order for products including photograph prints or a recording medium on which the information data is stored, the user can receive a value-added service, such as a file management service in the storage management server. In this manner, it is possible to motivate users to upload information data stored in a digital camera, a cell phone, or PC of each user, to the storage management server, to thereby promote the storage of the information data in the server.

The order phase includes a retailer system and a production system. The retailer system includes a system provided to a retailer such as a shop or a distributor, for receiving orders for products related to the information data stored in the storage management server and further for making order inquiries with regard to the information data stored in the storage management server. Specifically, the retailer system requests a user, when the user does daily shopping, to place an order for the products, in an encouraging manner, according to the storage status of the information data of the user managed by the storage management server. Further, the retailer system receives an order placed by the user, and transmits the order information to a production system. The production system performs a production process based on the received order information. In the manner as described above, it is possible to draw out a latent potential of an untapped market, that is, to derive an order for the information data that has merely been stored in the storage management server.

The order promotion system 10 shown in FIG. 1 includes an image/music information storage management server (hereinafter, referred to as storage management server) 12 which has the function of the above-mentioned storage phase, and a retailer system group 18 and a production system 22 which have the function of the order phase. The units shown in FIG. 1 are connected to one another via a known network such as the Internet and capable of communicating information.

The storage management server 12 includes a management server 14 and a storage server group 16 including a plurality of storage servers 16a to 16c. The retailer system group 18 includes a plurality of retailer systems 18a to 18c.

The management server 14 serves as a contact through which a user uploads information data to the storage management server 12. The management server 14 issues an arbitrary login ID (identification information) for each user, for authenticating individual users on a network.

When uploading information data to the storage management server 12, a user accesses a Web screen of the management server 14 to be authenticated by the login ID of the user, to thereby upload the information to specific one of the storage servers 16a to 16c.

Also, the management server 14 has a personal information database, which is not shown in FIG. 1. Registered in the personal information database are login IDs, identification information of each storage server as a specific storage destination, member IDs set in the retailer systems 18a to 18c to be described later, and inquiry information to be used when making order inquiries, which are associated with one another. The personal information database will be described later in detail.

The storage server group 16 is a unit for storing information data uploaded by users, and includes the plurality of storage servers 16a to 16c.

The storage servers 16a to 16c each serve different purposes depending on the business category or the business industry of each company. Accordingly, the storage servers 16a to 16c are in common with one another in providing service of storing information data, but different in storage capacity, storage period, and other service to be provided by those servers. The retailer systems 18a to 18c each include a specific one of the storage servers 16a to 16c, and provide a unique service in coordination with the specific storage server.

The storage servers 16a to 16c are each associated with a specific one of the retailer systems 18a to 18c. Depending on which of the retailer systems 18a to 18c is used by a user, it is determined which one of the storage servers 16a to 16c is used to store information data. When one of the retailer systems 18a to 18c issues a member ID to a user upon request from the user, identification information of the storage server associated with the retailer system is registered in the personal information database in the management server 14, together with the issued member ID and the inquiry information. The management server 14 also issues an login ID which is uniquely determined with respect to the registered member ID, and registers the login ID in the personal information database in association with the member ID, the inquiry information, and the identification information of the storage server.

The storage servers 16a to 16c each have a different server usage fee set thereto, and the retailer systems 18a to 18c are each charged with the server usage fee as appropriate, in accordance with each product order from each user, which will be described later in detail.

According to the system configuration of FIG. 1, three storage servers are illustrated. However, the present invention is not limited thereto, and may include one, two, or four or more storage servers.

The retailer system group 18 includes the plurality of retailer systems 18a to 18c, which correspond to shops or distributors which users use in their daily lives. Examples of the retailer systems 18a to 18c include business establishments such as a supermarket, a convenience store, and a photo shop, each including a sales management system through which commodities are purchased and settlement is made. One of the examples of the sales management system is a point of sales system (POS system) which is provided with an order system which operates in association with the storage management server 12. The retailer systems 18a to 18c each receive, through the POS system, orders for products from users, and transmits the content of each received order to a production system to be described later, as order information. Further, the retailer systems 18a to 18c each have different inquiry conditions for making order inquiries, and make order inquiries based on the inquiry conditions and the inquiry information to be described later.

The retailer systems 18a to 18c each include display means 20a to 20c, respectively. Each of the display means 20a to 20c can be viewed and operated by a user or an operator of each of the retailer systems 18a to 18c. The display means 20a to 20c each include a known monitor such as a touch panel, which can be operated by a user or an operator and displays the content of an order inquiry. It is preferable that both an operator and a user be allowed to view and operate the display means 20a to 20c. Therefore, it is preferable for the display means to be provided with a display screen on both sides thereof. The display means 20a to 20c may also display, in addition to the order inquiry, an amount or the like to a user at the time of settlement.

According to this embodiment, the order inquiry is made through a screen displayed by each of the display means 20a to 20c. However, the present invention is not limited thereto, and the order inquiry may be made through a voice command.

Also, FIG. 1 shows three retailer systems. However, the present invention is not limited thereto, and may include one, two, or four or more retailer systems.

Examples of the product include, in a case where the information data includes image data, photo prints, goods including a mug and a T-shirt, or a recording medium such as a CD-R. Further, in a case where the information data includes music data, an example of the product includes a recording medium such as a CD-R. The product may also include an electronic album provided with music, which is created by combining image data and music data.

The retailer systems 18a to 18c each issue a membership card by providing an arbitrary member ID to each user. Each member ID is associated with each login ID issued by the management server 14 and registered in the personal information database as described above, and used when making an order inquiry or processing an order, which will be described later.

According to this embodiment, the login ID is uniquely determined in the management server 14, while the member ID can be independently set in each of the retailer systems 18a to 18c. In other words, with respect to one user, one login ID and one or more member IDs are issued. Also, in this embodiment, the login ID and the member ID are different from each other. However, the present invention is not limited thereto, and the same ID may be used for both the login ID and the member ID.

Here, according to the present invention, in order to decide whether or not to make an order inquiry to each user and to determine the content of the order inquiry, first to third inquiry information and inquiry conditions are set.

The first inquiry information includes order inquiry authorization information indicating whether it is possible to make an order inquiry with regard to each information data based on the intention of each user, and order intention information on the user. To make an order inquiry, any of the retailer systems 18a to 18c makes an inquiry to a user, in a case where each information data stored in the corresponding one of the storage servers 16a to 16c has not been subjected to the order placement for the related product, as to whether or not to place an order for the information data or the product, to thereby encourage the user to place an order for the product. Each user may set in advance the order inquiry advisability information indicating whether the user allows the above-mentioned order inquiry to be made with regard to each information data or each product. The order inquiry advisability information is set, by default, such that the order inquiry is allowed to be made for all the information data items, and the user may change the settings of the information by designating any information data item or any product which the user does not want to be inquired about.

The first inquiry information is set through an input by each user at the time of membership registration in the corresponding one of the retailer systems 18a to 18c, and registered in the personal information database in the management server 14 in association with each member ID and login ID. After that, the first inquiry information can be changed, as needed by each user, through the management server 14 or a Web screen of the storage server selected by the user.

The second inquiry information includes information on the status of the information data stored in the storage server group 16 by a certain user. The second inquiry information includes upload date and time information on the latest date and time at which the information data is last updated and information as to whether there is stored any information data item about which the order inquiry has not been made. Further, as regards the information data about which the order inquiry has not been made, the second inquiry information includes information on the number of image data files for which a print order has not been placed, information on a size of each image data file for which a print order has not been placed, information on the number of image data files which have not been recorded on a CD-R, information on a size of each image data file which has not been recorded on a CD-R, information on the number of music data files which have not been recorded on a CD-R, and information on a size of each music data file which has not been recorded on a CD-R.

The second inquiry information is determined, upon request of the management server 14, by an analysis means (not shown) provided to each of the storage servers 16a to 16c, based on a storage status of the information data of each user in the corresponding one of the storage servers 16a to 16c, and transmitted to the management server 14. Alternatively, the analysis means may be provided to the management server 14, to which the storage servers 16a to 16c each transmit the storage status of the information data, and the management server 14 analyzes the received storage status with the analysis means, to thereby determine the second inquiry information.

It is preferable to make a decision as to whether to make an order inquiry or not by using both the first and second inquiry information. However, it is also possible to make the decision by using only one of the information.

Further, in a case of making an order inquiry to a user for the second time or later, it is preferable to give consideration to how the preceding order inquiry has been made so far, when making the decision as to whether to make the order inquiry or not. In view of this, it is preferable to make an order inquiry by using not only the above-mentioned first and second inquiry information, but also third inquiry information.

The third inquiry information includes information as to whether a user has placed an order in response to an order inquiry which has already been made to the user. In a case where the user has not placed an order despite the order inquiry made to the user, the management server 14 records the date and time and the content of the order inquiry, as the third information, in the personal information database in association with the login ID of the user.

In other words, the third inquiry information is used for determining a timing to make the next order inquiry, based on the contents of the preceding order inquiries which have been made so far.

The inquiry condition is used for determining whether or not to make an order inquiry and the content of the order inquiry, based on the first to third inquiry information. The inquiry condition is set in advance in each of the retailer systems 18a to 18c, and registered in a condition storage means provided to each of the retailer systems 18a to 18c.

Exemplary values which are each set as the inquiry condition include the order of priority of the first to third information, and a threshold value for determining whether or not to make an inquiry based on the second inquiry information.

The order of priority is not specifically limited, but it is preferable to set the inquiry condition such that the first inquiry information is given the highest priority and the third inquiry information is given the second highest priority. Specifically, in a case where a user allows an order inquiry to be made according to the first inquiry information, that is, the user has an intention to place an order, it is further determined, based on the content of the second information, whether to make an order inquiry or not. On the other hand, in a case where a user refuses to receive an order inquiry according to the first inquiry information, the inquiry condition is set so as not to make an order inquiry, regardless of the content of the second inquiry information.

In a case where a user has an intention to place an order for a certain information data item, according to the first inquiry information, that is, the information data item that has satisfied the inquiry condition regarding the first inquiry information, the information data item is compared with a threshold value set for each information item, based on the second inquiry information, to thereby determine whether to make an order inquiry or not.

The order inquiry condition with respect to the second inquiry information is set such that an inquiry can be made, for example, in a case where the number of image data files for which a print order has not been placed has exceeded a certain predetermined value, in a case where the latest upload date and time of the information data is within the past three days, or in a case where a data size has exceeded a certain amount.

The above-mentioned threshold values are each set by assuming an exemplary case where, when free space in the storage server is running short, a user places an order for a product such as a print or a CD-R in relation to the stored information data, so as to allow the information data in the storage server to be deleted to increase the free space therein, to thereby enable the upload of new information data. Accordingly, it is preferable to set the condition such that an order inquiry is made when the free space in the storage server is scarce. Also, the free space in the storage server may be displayed to a user when making an inquiry to the user, to thereby inform the user that the free space is running short, which makes it possible to more efficiently promote the placement of an order.

Also, the condition may preferably be set such that a user is encouraged to place an order each time when new information data is uploaded by the user.

Next, examples of the order inquiry condition with respect to the third inquiry information include a condition of suspending, in a case where a user has not placed an order regardless of an inquiry which has been made previously, another inquiry to be made thereafter, a condition of not making an order inquiry until the user comes to the retailer for a predetermined times, and a condition of not making an order inquiry until new information data is uploaded to any of the storage servers 16a to 16c. It should be noted that, to derive the number of times the user has visited the retailer, dates on which the member ID is read by any of the retailer systems 18a to 18c may be recorded.

By using the third inquiry information, it is possible to avoid repeatedly making the same inquiries to a user in a case where an order inquiry has already been made to the user but the user has no intention to place an order and no order has been placed, to thereby make it possible to make an order inquiry without causing offense to the feelings of the user.

According to this embodiment, by way of example, in a case where the first inquiry information has satisfied the inquiry condition, of the order contents which have satisfied the inquiry condition with respect to the second inquiry information, only the order contents which have satisfied the inquiry condition set for the third inquiry information are used as an order inquiry.

In other words, priorities are assigned to the first inquiry information, the third inquiry information, and the second inquiry information, in this order.

Also, the first to third inquiry information may be changed as appropriate, according to the storage status or the order status of the information data by a user or according to a user's intention of placing an order.

Further, the inquiry conditions can be changed as appropriate according to the business policy and the service contents of each retailer, to thereby allow each of the retailer systems 18a to 18c to customize its own service and provide the service.

The production system 22 is a unit for producing a product ordered by the retailer system group 18. The production system 22 includes a production system such as a major laboratory, or a mini-laboratory installed in each shop of the retailer system group 18.

When the production system 22 has received order information from the retailer system group 18, the production system 22 performs production of a product based on the information.

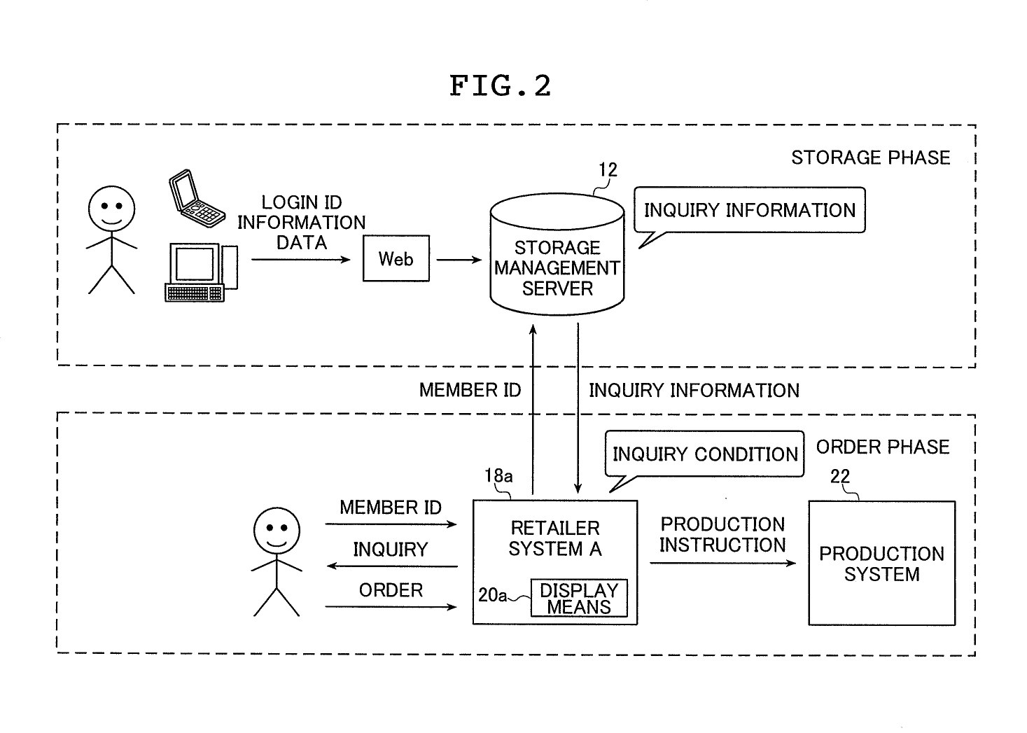

Next, a flow of a process performed in the order promotion system 10 of FIG. 1 will be described in detail with reference to FIGS. 1 and 2.

First, a user visits one of the retailer systems 18a to 18c, which corresponds to a shop such as a supermarket or a convenience store, and makes membership registration. In this case, by way of example, the user makes membership registration in the retailer system 18a. However, even in a case where the user makes membership registration in any other retailer system, the same process flow as described below will be performed.

The retailer system 18a issues a membership card registering a member ID to a user, to thereby register the user for membership. The membership card is issued to each user by a retailer system and the user uses the membership card to be rewarded with services in the retailer system. An example of the membership card includes a known card such as a reward card.

The retailer system 18a causes a user to input the first inquiry information, to thereby input the order intention information and further determine whether or not to make an order inquiry and input the result thereof. The retailer system 18a further causes the user to input personal information such as an address and a telephone number if necessary. Further, when the retailer system 18a has issued, to the user, a membership card registering the member ID of the user, the retailer system 18a automatically accesses the management server 14, and transmits the identification information of the retailer system 18a, the member ID, the first inquiry information input by the user, the personal information of the user, and the identification information of the storage server as a storage destination corresponding to the retailer system 18a. The identification information of the storage server is set in the retailer system 18a in advance.

The management server 14 issues, in response to a request from the retailer system 18a, a unique login ID based on the identification information of the retailer system 18a and the member ID, and transmits the unique login ID to the retailer system 18a. Further, the management server 14 registers the login ID in the personal information database, in association with the member ID, the first inquiry information, the personal information of the user, the identification information of the storage server, and the identification information of the retailer system 18a, which have been received from the retailer system 18a.

Next, a flow of a process to be performed in the storage phase will be described.

Having made the membership registration, the user logs into the system through the Web screen of the management server 14 by using the issued login ID, and a transition to the storage server set by the retailer system 18a automatically takes place, to thereby allow the user to upload information data and to receive various services. In other words, the management server 14 serves as a common contact to make a transition to each of the storage servers 16a to 16c. In this case, by way of example, the storage server 16a is set as a storage server corresponding to the retailer system 18a. However, even in a case where any other storage server is set, the same process flow as described below will be performed.

The user accesses the Web screen of the management server 14 from an image pickup device with a communication function, such as a cell phone, a PC, or an MP3 player, and inputs a login ID. The management server 14 searches the personal information database to read out the identification information of the storage server 16a associated with the input login ID, and the screen is caused to transition to the Web screen of the corresponding storage server. The user uploads, through the Web screen of the corresponding storage server, desired information data to the storage server.

The information data thus uploaded is stored in and managed by the storage server 16a, in association with the login ID.

In the manner as described above, the retailer system is capable of designating a storage server to be used by a user. Accordingly, when the storage server is set as a server uniquely owned by a retailer or a server provided by an affiliated company, it is possible to provide service which requires a strong connection between the retailer system and the storage server, to thereby efficiently operate the retailer system in coordination with the storage server.

Next, a flow of a process to be performed in the order phase will be described.

After storing information data, when the user does shopping at the retailer and presents the membership card when checking out, an operator (such as a salesclerk of the retailer) processes the user's purchase while the member ID is read through the retailer system 18a and transmitted to the management server 14.

The management server 14 searches the personal information database for a login ID corresponding to the received member ID, and reads out first inquiry information corresponding to the login ID. Further, based on the identification information of the storage server corresponding to the login ID, the management server 14 identifies a storage server selected by the user from among the storage servers 16a to 16c, and requests the corresponding storage server for the second and third inquiry information based on the information data owned by the storage server and information on the usage fee of the storage server. The storage server creates, based on the information data of the user owned by the storage server, the second and third inquiry information, and informs the management server 14 of the second and third information together with the information on the usage fee of the storage server. The management server 14 transmits the first inquiry information registered in the personal information database, the second and third inquiry information received from the storage server, and the information on the usage fee of the storage server, to the retailer system 18a.

The retailer system 18 analyzes the first to third inquiry information received from the management server 14, and compares the information with the inquiry conditions set in the retailer system 18a, and judges whether it is possible to make an order inquiry to the user and determines the content of the inquiry.

In the case where it has been judged as the result of the judgment that it is possible to make an order inquiry, the display means 20a of the retailer system 18a displays the kinds of products about which an order inquiry can be made.

The order inquiry is made by causing the display means 20a to display an indication for informing the user that there is unordered data. The user sees the indication on the display means 20a and, when the user desires to place an order for the unordered information data, places an order on the spot by operating the touch panel of the display means 20a.

Alternatively, the display means 20a of the retailer system 18a may display, to the operator, an indication informing that there is unordered information data, such as “There is unordered data. Please make an inquiry to the user about the data,” and the operator, upon observing the indication, may verbally make an inquiry to the user.

In this case, the user may verbally inform the operator of the user's intention to place an order, and the operator may operate the retailer system 18a to input the content of the order.

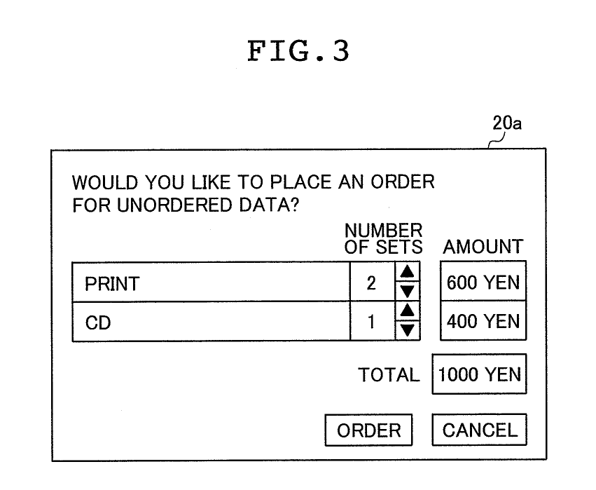

FIG. 3 shows an example of an order screen to be displayed by the display means 20a. FIG. 3 shows, by way of example, an exemplary screen to be displayed in a case where the second inquiry information set to the retailer system 18a includes information on the number of image data files for which a print order has not been placed and information on the number of image data files which have not been recorded on a CD-R.

In FIG. 3, displayed are two kinds of products including a print and CD-R as producible products in association with the second inquiry information, and further displayed are the numbers, the amounts, and the total of the products. The display of products may be changed as appropriate according to the content of the second inquiry information.

The number of products may be set in units of sets. For example, in a case of a print, each set includes prints printed with respect to all the image data items on a one-to-one basis. Then, the amount for each product and the total amount of all the orders are displayed together with the number of products.

In the case where the information data about which the order inquiry is to be made includes image data, part of the image data may be displayed as thumbnail-size images, for example, at the bottom of the order screen.

In view of the case where the product includes prints, the number of prints to be printed may be automatically set in advance for each image data item through a face detection function for image data in the storage server 16a. Specifically, when image data is uploaded to the storage server 16a, the storage server 16a identifies the number of faces in each image corresponding to each image data item, by using a known face detection function. Then, the number of faces thus identified is stored in association with each image data item, as the number of prints to be printed for the image data item. When a print order for the image data is made in the retailer system 18a, the numbers of prints thus associated with the image data are automatically set as a default value.

Alternatively, when information data is uploaded by a user or when the user logs into the management server 14 thereafter, the user may arbitrarily set the number of prints to be ordered for each image data item and the number of prints may be associated with each image data item.

To place an order for a product, a user sets the number of each product by operating the touch panel or the like of the display means 20a and presses an order button. When an order is placed by a user, the retailer system 18a indicates the total amount to be paid, which is obtained by adding the cost corresponding to the content of the order to the amount of a purchase made by the user at the retailer. In other words, the user is charged for the order together with the amount of a purchase at the retailer system 18a. The user pays the sum total of the cost of shopping and the cost of the order.

The cost of each product is set based on the usage fee of the storage system, which has been received by the retailer system 18a from the management server 14. Specifically, the retailer system 18a charges each user for the sum of the production cost of the product in the production system and the server usage fee of the storage server 16a.

As described above, an order for a product can easily be made by each user through a simple operation at the time of settlement at the retailer system 18a.

When the payment is settled, the retailer system 18a transmits the input order content, as the order information, to the production system 22. When the order information is received, the production system 22 obtains, from the storage server 16a, information data corresponding to the order information, and starts producing the product.

At the time of settlement at the retailer, the retailer system 18a may indicate a production completion time to the user. For example, in the case where the retailer is a supermarket, the product may be produced by the production system 22 provided to a photo shop located within the premises of the retailer. In this case, the retailer system 18a obtains information on the operational status of the production system 22, and calculates working hours or the like necessary for the production and the packaging of the product, to thereby determine whether it is possible or not to deliver the product to the user in several minutes during which the user packs the merchandise in bags and then heads to the photo shop, that is, whether it is possible to make the delivery on the spot. Then, when it has been determined that the delivery is possible, the retailer system 18a informs the user accordingly through the display on the screen. On the other hand, in a case where the production of the product requires time or in a case where the production system 22 is not located within the premises of the retailer, it is difficult to make the delivery on the spot, and therefore the retailer system 18a may inform the user of the date and time on which the delivery can be made, which allows the user to visit the retailer on the date and time thus informed to receive the product. Further, the retailer may be a shop which is visited daily by the user. Accordingly, on the next visit of the user to the retailer, the retailer system 18a may display a message or the like for reminding the user to receive the product ordered by the user, so that the user can receive the product even when the user has forgotten about the placed order.

Also, an address or the like of each user may be registered at the time of membership registration, so as to make home delivery of the completed product to the user. In this case, the retailer system 18a may be provided with a printing function of a delivery form, and the delivery form may be printed out at the time of placement of an order.

In the order promotion system according to the present invention, when the order for a product has been placed and the production of the product has started, the product has already been charged. Accordingly, the product can be delivered to each user in various ways depending on the needs of each user.

According to the above-mentioned embodiment, in each of the retailer systems 18a to 18c, a storage server to be used by a user is automatically determined. However, the present invention is not limited thereto, and a login ID is first issued to each user by the management server 14 so as to allow each user to select a storage server according to the user's preference.

Hereinbelow, an embodiment corresponding to the case as described above will be described in detail.

The user, who is uploading information data for the first time, accesses the Web screen of the management server 14 through a cell phone or a PC. Next, the user selects, from the storage server group 16, a storage server to which the user desires to upload the information data. The user may select a storage server depending on a type of service the user wants to receive. In this case, by way of example, the storage server 16a is selected. However, even in a case where any other storage server is selected, the same process flow as described below will be performed.

Subsequently, the user inputs the first inquiry information, and further inputs personal information if necessary.

The management server 14 issues a login ID to the user, and registers the login ID, in the personal information database, in association with the first inquiry information and personal information input by the user, and identification information of the storage server selected by the user, to thereby make user registration.

The user inputs the issued login ID next time the user accesses the Web screen of the management server 14, and the user is automatically led to the Web site of the storage server the user has selected at the time of user registration.

After the login registration has been completed, the user visits a retailer corresponding to the storage server 16a selected by the user, and makes membership registration through the retailer system 18a. At the time of membership registration, the retailer system 18a asks the user to report the login ID issued by the management server 14. When the membership registration has been made, the retailer system 18a transmits a member ID of the issued membership card to the management server 14, together with the login ID reported by the user. The management server 14 retrieves, based on the received login ID, a login ID registered in the personal information database, and registers the received member ID in the personal information database in association with the retrieved login ID.

After that, as in the above-mentioned embodiment, the information data can be uploaded by the user and an order inquiry can be made through the retailer system.

Alternatively, the management server 14, when making user registration, may automatically obtain a new member ID from the retailer system 18a which corresponds to the storage server 16a selected by the user, and may register the obtained member ID, in addition to the above-mentioned information including the login ID or the like, in the personal information database.

Further, according to the above-mentioned embodiment, the order screen has a simple structure as shown in FIG. 3. However, in a case where the user wants to take time to decide on the content of an order, a detailed order system may also be provided to the retailer, apart from the display means 20a to 20c each installed in the retailer systems 18a to 18c, respectively, and the user places an order by using the detailed order system. In the case where the user desires to place a detailed order, the retailer systems 18a to 18c each transfer each inquiry information and inquiry conditions, which have been received from the management server 14, to the detailed order system which is installed at a predetermined site within the store corresponding to the retailer. The detailed order system displays, based on the received information, an order screen through which a detailed order is placed. In this case, thumbnail-size images corresponding to image data are displayed, and the user makes detailed settings for each image, regarding whether or not to place an order therefor, the number of prints to be ordered, and how the image is processed, to thereby place an order. When a user is having difficulty in immediately deciding on the content of an order to be placed in any of the retailer systems 18a to 18c, the detailed order system allows the user to take time to place the order. The content of the order placed through the detailed order system is transmitted, similarly to the orders placed through the retailer systems 18a to 18c, to the production system 22, and the production of the product is started.

Also, in the case where the information data on which the order inquiry is made includes image data, an index print may be printed by any of the retailer systems 18a to 18c and provided to the user, so as to allow the user to take time later to carefully consider the order to be placed, with reference to the index print.

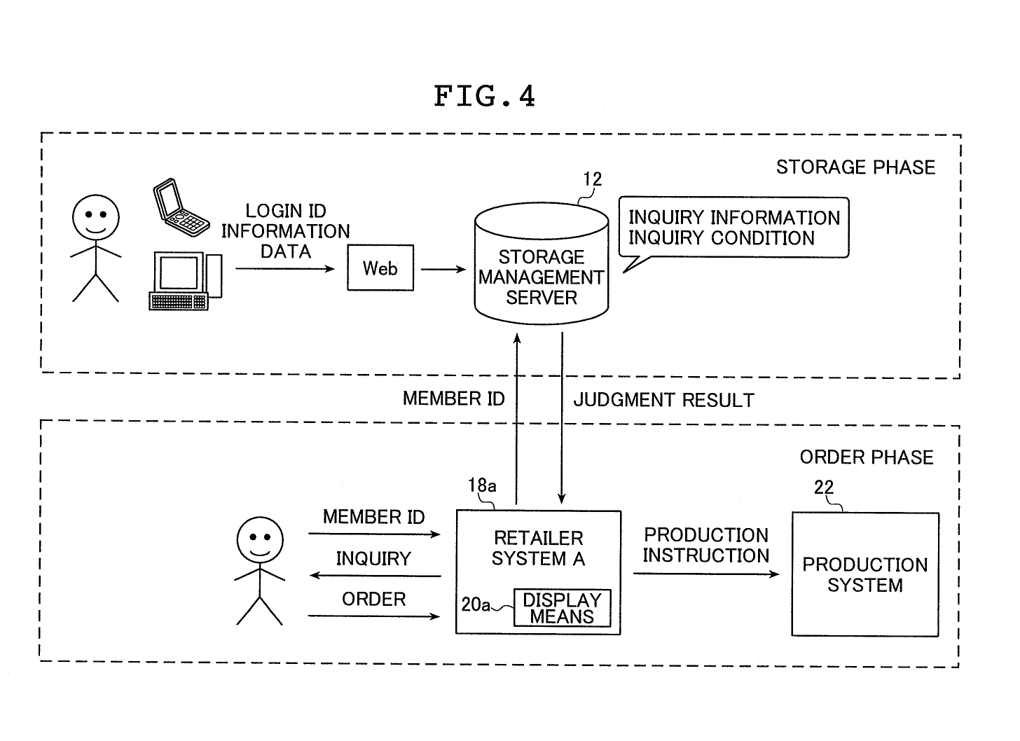

According to the above-mentioned embodiments, the inquiry condition is set to each of the retailer systems 18a to 18c, so as to allow each of the retailer systems 18a to 18c to customize its own service and provide the service. However, the present invention is not limited thereto, and the management server 14 may collectively set and hold one inquiry condition. For example, in a case of constructing the system with a simple structure as illustrated in FIG. 4, the retailer systems are not differentiated from one another, and all the inquiry information and the inquiry conditions are managed and analyzed by the management server 14 which is centrally managing each storage server, so that the retailer systems are notified only of the result of judgment on the order inquiry, to thereby facilitate maintenance of the order promotion system as a whole.

Also, the first to third inquiry information may be held in the personal information database of the management server 14. Alternatively, the retailer systems 18a to 18c may each hold part or all of the first to third inquiry information.

Further, according to the present invention, in a case where the information data is obtained through an image pickup device connectable to a network, such as a cell phone with camera, for example, image data obtained by the image pickup device may be automatically uploaded to the management server 14 each time the image pickup device takes one image. At this time, a login ID is transmitted from the image pickup device to the management server 14, together with the image data, and the image pickup device automatically logs into the management server 14. The login ID in this case may be set in advance at the time of login registration through the Web screen of the management server 14. Alternatively, an identification ID independently owned by each model of the image pickup device may be used as the login ID.

As described above, the order promotion system according to the present invention provides service of storing and managing information data of each user by the storage management server, to thereby entice information data of users to the storage management server and to attain a right to manage an enormous amount of information data.

Also, an order inquiry is periodically and actively made to each user so as to encourage the user to place an order, which effectively derives an order regarding the information data which otherwise has merely been stored in the storage server, to thereby make a profit. Further, it is decided whether it is possible or not to make an order inquiry, based on the inquiry information and the inquiry conditions, which allows the retailer system to be linked with the storage server to identify the type of stored information of the information data of each user, and to make an order inquiry according to the type of the stored information of the information data in the storage server, without causing offense to the feelings of the user, to thereby increase the utility of the system.

Further, a member ID issued by the retailer system and a login ID issued by the management server are managed in association with each other, which makes it possible to request the placement of an order from each user who has no intention of placing an order for a product, during a daily-life activity such as shopping at a supermarket or a convenience store, which is alienated from the placement of an order for a product. Also, an order can be placed by taking an advantage of daily shopping at a retailer, and the ordered product is charged additionally to the amount of a purchase made at the retailer. Accordingly, as compared with a case where a user takes the trouble of visiting a photo shop or the like to merely place an order for a product, it is possible to ease user's psychological discomfort in making an order, to thereby enhance an effect of promoting an order.

Further, each user can place an order by taking an advantage of shopping at retailers providing various kinds of services, which eliminates the conventional need to take the trouble of visiting the retailer only for the purpose of placing an order or receiving a product, to thereby increase the convenience of users.

Also, when an order is placed by a user at the retailer system, the payment is made on the spot, which makes it possible to charge the order simultaneously with the placement thereof. Accordingly, it is possible to avert a risk in security which occurs when the payment is settled with a credit card, and also to prevent mischievous orders from being placed, which otherwise occurs when the product is charged upon the reception thereof or when the product is sent on cash on delivery.

In the above, the order promotion system according to the present invention has been described in detail. However, the present invention is not limited to the above-mentioned various embodiments, and may be subjected to various modifications and alterations without departing from the spirit of the present invention.

What is claimed is:

1. An order promotion system, comprising:
a storage management server; and
at least one retailer system,
said storage management server comprising:
an acquisition means for acquiring one of information data including one of image data and music data uploaded by a user through a communication network, and a storage status of said information data thus uploaded;
an analysis means for analyzing order inquiry information related to said information data, based on the acquired one of said information data and said storage status; and
a storage means for storing one of said information data and said storage status, in association with said order inquiry information,
said at least one retailer system comprising:
an identification information acquisition means for acquiring a member identification information of the user;
a condition storage means for storing an order inquiry condition; and
a sales management function of managing sales of commercial products,
wherein:
said retailer system transmits said member identification information acquired by said identification information acquisition means, to said storage management server;
said storage management server reads out, from said storage means, said order inquiry information corresponding to said received member identification information, and transmits said order inquiry information to said retailer system; and
said retailer system judges, based on said order inquiry information received from said storage management server and said order inquiry condition stored in said condition storage means, whether it is possible to make an order inquiry to the user with regard to one of said information data and each of said commercial products, determines a content of said order inquiry, and makes an order inquiry based on a judgment result corresponding to a result of the judgment and the determination.

2. An order promotion system, comprising:
a storage management server; and
a retailer system,
said storage management server comprising:
an acquisition means for acquiring one of information data including one of image data and music data uploaded by a user through a communication network, and a storage status of said information data thus uploaded;
an analysis means for analyzing order inquiry information related to said information data, based on the acquired one of said information data and said storage status;
a storage means for storing one of said information data and said storage status, in association with said order inquiry information; and
a condition storage means for storing an order inquiry condition,
said retailer system comprising an identification information acquisition means for acquiring a member identification information of the user,
wherein:
said retailer system transmits said member identification information acquired by said identification information acquisition means, to said storage management server;
said storage management server reads out, from said storage means, said order inquiry information and said order inquiry condition each corresponding to said received member identification information, judges, based on said order inquiry information and said order inquiry condition, whether it is possible to make an order inquiry to the user with regard to one of said information data and each of commercial products, determines a content of said order inquiry, and transmits a judgment result corresponding to a result of the judgment and the determination, to said retailer system; and
said retailer system makes an order inquiry based on said received judgment result.

3. The order promotion system according to claim 1, wherein:
said storage management server comprises an authentication means for authenticating a user uploading said information data, based on a login identification information of the user; and
said storage means stores said uploaded information data, in association with said login identification information and said member identification information.

4. The order promotion system according to claim 1, wherein
said order inquiry information comprises at least one of first inquiry information and second inquiry information,
said first inquiry information including order inquiry authorization information and order intention information of a user regarding one of said information data and each of said commercial products,
said second inquiry information including at least one of: information on the time at which said information data has been last uploaded; information as to whether there is stored any information data item about which an order inquiry is yet to be made; information on the number of image data files for which a print order is yet to be placed; information on a size of the image data files for which a print order is yet to be placed; information on the number of the image data files yet to be recorded on a recording medium; information on a size of the image data files yet to be recorded on a recording medium; information on the number of music data files yet to be recorded on a recording medium; and information on a size of the music data files yet to be recorded on a recording medium.

5. The order promotion system according to claim 4, wherein:
said order inquiry condition comprises a condition for judging, based on said order inquiry information, whether it is possible or not to make an order inquiry with regard to one of said information data and each of said commercial products;
said first inquiry information has a condition that a user allows an order inquiry to be made and has an intention of placing an order, as said order inquiry condition;
said second inquiry information has a result of a comparison between each of the information data items and a predetermined threshold value, set as said order inquiry condition; and
when all the order inquiry conditions are satisfied, it is judged that an order inquiry is possible.

6. The order promotion system according to claim 5, wherein:
said order inquiry information further comprises information including a content of an order inquiry made to a user and a date and time on which said order inquiry has been made in response to which the user has not placed an order, as third inquiry information; and
said order inquiry condition is set such that the judgment as to whether it is possible to make an order inquiry is allowed to be made according to said third inquiry information, only in a case where it has been judged, according to said first inquiry information, that said order inquiry is possible and a user has an intention of placing an order.

7. The order promotion system according to claim 1, wherein said retailer system comprises a display means for displaying, based on said judgment result, commercial products about which an order inquiry can be made.

8. The order promotion system according to claim 1, further comprising a production unit for performing a production process for producing a corresponding one of the commercial products based on an order placed by a user through said retailer system, wherein:
said retailer system comprises an order reception means for receiving an order from a user;
said order reception means, upon receiving an order from a user in response to said order inquiry, charges said user for said order, and transmits order information to said production unit; and
said production unit, upon receiving said order information, obtains, from said storage management server, said information data corresponding to said order information, and performs said production process.

9. The order promotion system according to claim 1, wherein:
said storage management server comprises a management server and at least one storage server storing server usage fee information;
said storage means stores identification information of said at least one storage server in association with said member identification information;
said storage management server, upon receiving said member identification information from said retailer system, reads out said identification information of said at least one storage server which has been associated with said member identification information by said storage means, obtains said server usage fee information of said at least one storage server, and notifies said retailer system of said server usage fee information; and
said retailer system charges the user for an amount obtained by adding a server usage fee based on said notified server usage fee information to a production fee of the corresponding one of said commercial products.

10. The order promotion system according to claim 3, wherein:
said retailer system issues a new member identification information and transmits said new member identification information, together with identification information of said retailer system, to said storage management server;
said storage management server issues a new login identification information based on said new member identification information and said identification information of said retailer system received from said retailer system; and
said storage means stores and manages said new member identification information and said new login identification information in association with each other.

11. The order promotion system according to claim 3, wherein:
said retailer system issues a new member identification information and transmits said new member identification information, together with a login identification information reported by a user, to said storage management server; and
said storage management server stores and manages, in said storage means, said received new member identification information and said login identification information in association with each other.

12. The order promotion system according to claim 3, wherein
said authentication means, upon acquiring said login identification information, reads out, from said storage means, said identification information of said corresponding storage server, based on said member identification information associated with said login identification information, and automatically effects a transition to said specific storage server based on said identification information of said storage server.

13. The order promotion system according to claim 1, wherein said storage management server further comprises a face detection means for determining, in a case where said uploaded information data includes image data, the number of faces, and providing said number of faces as the number of prints to be ordered for said image data, to said image data as additional information.

14. The order promotion system according to claim 1, wherein the storage management server further comprises a number setting function of allowing a user to arbitrarily set the number of commercial products to be produced for image data.

15. The order promotion system according to claim 1, further comprising a detailed order unit for making a setting in detail on an order, based on said order inquiry information and said order inquiry condition, wherein
said retailer system transfers said order inquiry information and said order inquiry condition to said detailed order unit.

16. The order promotion system according to claim 8, wherein said retailer system comprises a print unit for printing a delivery form to be used for delivering the corresponding one of said commercial products to a user.

17. The order promotion system according to claim 8, wherein said order reception means comprises means for calculating a production completion time of the corresponding one of said commercial products based on said order information and indicating the production completion time to a user.

18. A storage management server provided to said order promotion system according to claim 1.

19. A retailer system provided to said order promotion system according to claim 1.
